(19) United States
(12) Patent Application Publication
(10) Pub. No.: US 2019/0383200 A1
(43) Pub. Date: Dec. 19, 2019

(54) HANGER CLAMP ASSEMBLY

(71) Applicant: MBRP, Inc., Huntsville (CA)

(72) Inventors: Craig David Beckner, Utterson (CA); Christopher Allan Brazier, Utterson (CA)

(21) Appl. No.: 16/264,569

(22) Filed: Jan. 31, 2019

Related U.S. Application Data
(60) Provisional application No. 62/624,512, filed on Jan. 31, 2018.

(51) Int. Cl. F01N 13/18; B60K 13/04; F16L 3/24

(52) U.S. Cl. CPC F01N 13/1822; F16L 3/24; B60K 13/04

(57) ABSTRACT

A hanger clamp assembly having hanger rods and a band clamp attached to a bracket. The hanger rods can be manufactured at specific lengths and with desired bends so as to be mounted to many different makes and models of internal combustion engine powered cars and trucks.

### CROSS REFERENCE TO RELATED APPLICATION

This application claims the benefit of U.S. Provisional Application No. 62/624,512, filed Jan. 31, 2018.

### FIELD OF THE INVENTION

This invention relates to a hanger clamp assembly for an exhaust system of a vehicle. More particularly, this invention relates to a universal hanger clamp assembly for exhaust systems of a variety of vehicles.

### BACKGROUND OF THE INVENTION

In the past, hanger clamps for securing exhaust pipes underneath motor vehicles consisted of a hanger rod welded to a standard dimensioned saddle or band clamp. In other applications, rod hangers were welded directly to exhaust tubes. Ensuring correct alignment of the hanger rod when welding to a standard dimensioned saddle or band clamp, or directly to an exhaust tube, is difficult and therefore takes significant time. Furthermore, the hanger assemblies frequently are subsequently zinc plated to provide corrosion resistance which leads to complicated and extended supply chains. With many different products, the set-up times in preparation to weld the hangers is often more significant than the weld run time since each setup is typically unique.

While welding hangers directly to a saddle clamp is relatively simple, band clamps do not provide an easy way to attach hangers. This presents a difficulty for manufactures since customers increasingly prefer band clamps over the traditional saddle clamps. Lastly, hangers welded to clamps often have complicated geometries making them difficult to package and ship cost effectively. A common complaint in the exhaust industry is that the welded hanger clamps burst packaging during shipment.

### SUMMARY OF THE INVENTION

The applicant, a designer of automotive exhaust systems, has invented a hanger clamp assembly having a bracket with a universal design to which a variety of different hanger rods can be attached so that the hanger clamp assembly can be mounted to many different makes and models of internal combustion engine powered cars and trucks. This approach is counter intuitive since it is generally accepted that a person skilled in the art would not want to add additional parts to the assembly, thus increasing the cost and weight of the product. The applicant has appreciated that such a universal hanger clamp assembly allows for the hanger rod to be welded directly to the bracket which can be mechanically fixed to the band clamp with the strength and longevity required for exhaust applications either before or after shipment to the customer. It also significantly lowers the set-up cost and fixturing cost required to weld the hanger clamp assembly together. The universal hanger clamp assembly permits the use of robotic welding as well as reduces the necessity to have clamps zinc plated since the hanger rods are not welded directly to the band clamps. Lastly, the universal hanger can be fixed to the band clamp easily, and the quality and density of the packaging can be improved.

In particular, the current invention is directed to a hanger clamp assembly that can:

1. Be used in a vast majority of products while providing the strength, and longevity required to hold an exhaust system under a vehicle;
2. Significantly lower the set-up cost and time required to weld the hanger to the universal end, and be robotically welded so that the run cost savings at least offset the additional cost of the universal clamp and welding process;
3. Enable manufacture of universal hanger clamp that works on most standard band clamps; and
4. Ease installation and packaging.

In one embodiment, the current invention resides in a hanger clamp assembly for connecting a vehicle exhaust system to a vehicle body, comprising: a formed bracket and one or more hanger rods being sized and bent in an orientation for a specific vehicle, each of the one or more hanger rods having a proximal end and a distal end, the proximal end of the one or more hanger rods being fixed to the formed bracket; a clamp attached to the bracket, the clamp being sized to fit around a vehicle exhaust pipe, and the hanger clamp assembly being connected to the vehicle by attaching the distal end of the one or more hanger rods to one or more mounts on the underside of the vehicle and a vehicle exhaust pipe being secured within the clamp.

Preferably, the bracket further has at least one first weld slot, and the proximal end of the at least one hanger rod is fixed to the at least one first weld slot.

Preferably, the at least one weld slot has a width that is approximately 60% of a diameter of the at least one hanger rod.

Preferably, the at least one weld slot has a length that is approximately 150% of the diameter of the at least one hanger rod.

More preferably, there are two hanger rods, namely a first hanger rod and a second hanger rod, and each of the first and second hanger rods are fixed to the formed bracket.

Preferably, the bracket further has at least one first weld slot and at least one second weld slot, and the proximal end of the first hanger rod is welded to the at least one first weld slot, and the proximal end of the second hanger rod is welded to the at least one second weld slot.

Preferably, the at least one first and the at least one second weld slots have a width that is approximately 60% of a diameter of the respective first and second hanger rods.

More preferably, the at least one first weld slot and the at least one second weld slot have a length that is approximately 150% of the diameter of the respective first and second hanger rods.

Still more preferably, the formed bracket is generally a modified S-shape.

Preferably, the proximal end of the at least one hanger rod is cylindrical and is bent in substantially a same shape as a contour of the modified S-shape of the bracket.

More preferably, the clamp is a standard commercially available band clamp.

Preferably, the bracket has a hole therethrough, and the band clamp has a bolt for tightening the band around an exhaust pipe, the hole in the bracket being sized such that the bolt is insertable therethrough and a nut is threadable onto the end of the bolt to secure the bracket to the band clamp.

Still more preferably, the hole has a keyhole shape.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a hanger clamp assembly in accordance with the Prior Art shown in perspective view;

FIG. 2 shows a hanger clamp assembly in accordance with the current invention;

FIG. 3 shows the first hanger rod and the second hanger rod attached to the bracket from the hanger clamp assembly in FIG. 2;

FIG. 4 shows the bracket from the hanger clamp assembly shown in FIG. 2;

FIG. 5 shows the hanger clamp assembly of FIG. 2 attached to the underside of a vehicle;

FIG. 6 shows a hanger clamp assembly in accordance with another embodiment of the current invention;

FIG. 7 shows the hanger rods attached to the bracket of the hanger clamp assembly shown in FIG. 6;

FIG. 8 shows the hanger clamp assembly of FIG. 6, in side view, with the hanger rods and bracket positioned for attachment to the clamp;

FIG. 9 shows the hanger clamp assembly of FIG. 6, in perspective view, with the hanger rods and bracket positioned for attachment to the clamp;

FIG. 10 shows the hanger clamp assembly of FIG. 6 attached to a vehicle in a perspective view;

FIG. 11 shows the hanger clamp assembly of FIG. 6 attached to a vehicle in a perspective side view; and

FIG. 12 shows the hanger clamp assembly of FIG. 6 attached to a vehicle in another perspective side view.

### DETAILED DESCRIPTION OF THE PREFERRED EMBODIMENTS

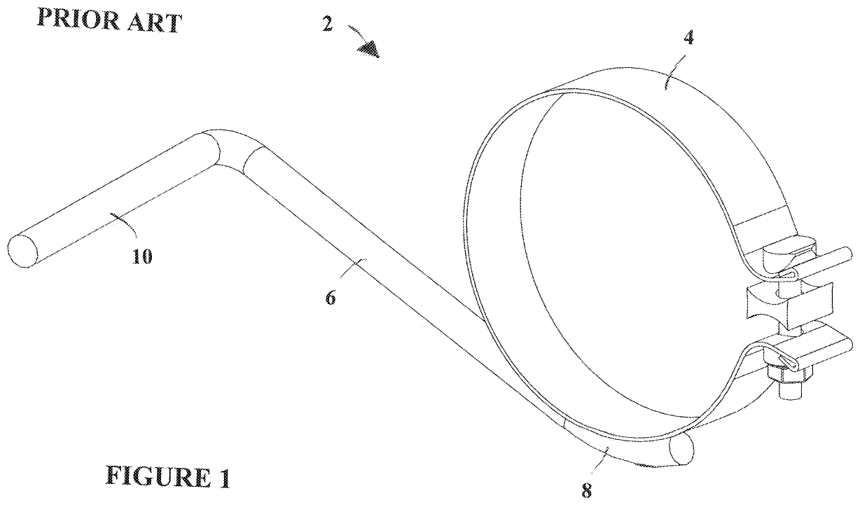

FIG. 1 shows a hanger clamp assembly 2 in accordance with the Prior Art. The hanger clamp assembly 2 has a band clamp 4 and a hanger rod 6. The hanger rod 6 has a distal end 8 and a proximal end 10. The band clamp 4 is welded to the hanger rod 6 at the distal end 8.

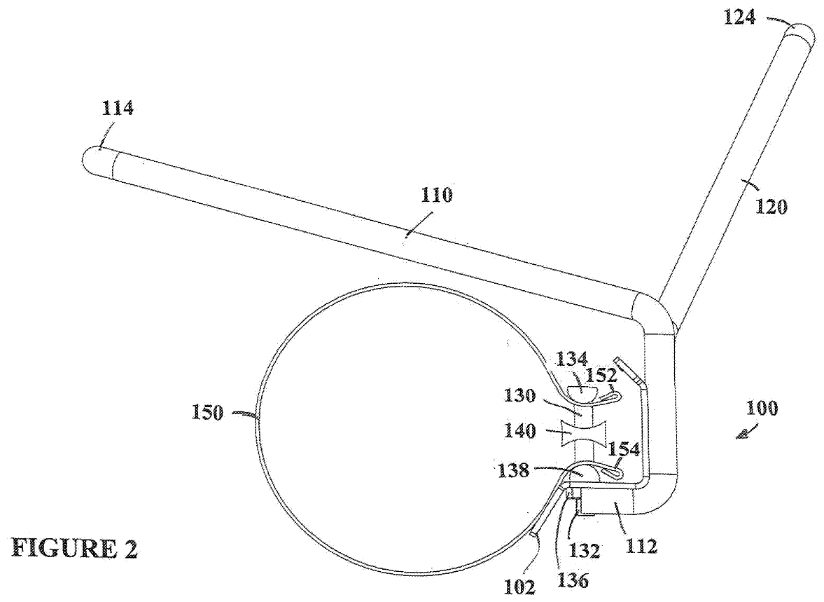

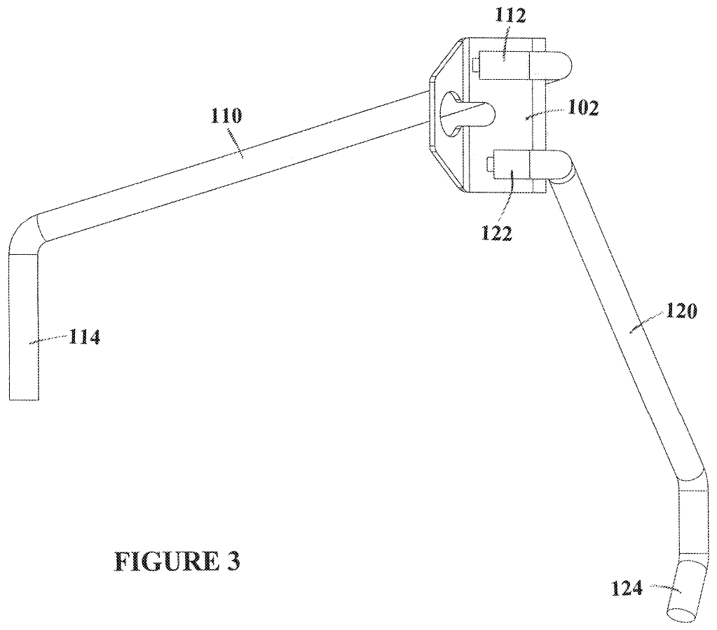

FIG. 2 shows a hanger clamp assembly 100 in accordance with one embodiment of the current invention. The hanger clamp assembly 100 has a bracket 102. A first hanger rod 110 has a proximal end 112 which is welded to the bracket 102, and a distal end 114 which is attachable to a vehicle (not shown). A second hanger rod 120 has a proximal end 122, as shown in FIG. 3, which is welded to the bracket 102, and a distal end 124 which is attachable to a vehicle (not shown).

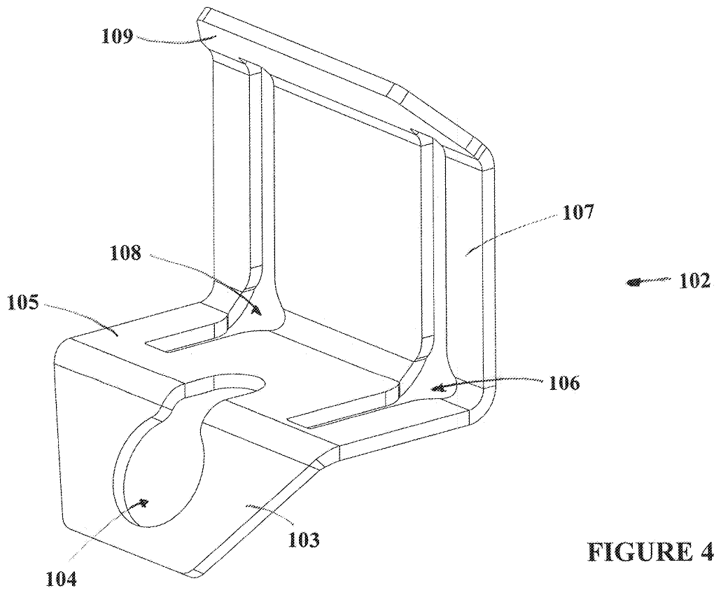

A bolt 130 has a first end 132 and a second end 134. The first end 132 is threaded and is inserted through a hole 104, as shown in FIG. 4. A nut 136 is threaded on the first end 132 to secure the bolt 130 to the bracket 102. As shown in FIG. 2, there is also a dome shaped washer 138 which is positioned on the bolt 130. A spacer 140 is also positioned on the bolt. The spacer 140 has a concave profile, as shown.

A band clamp 150 has a first end 152 and a second end 154. The first end 152 and the second end 154 have apertures proximate thereto. The apertures are sized to permit the bolt 130 to pass through so that the band clamp 150 can be secured to the bracket 102. In use, the band clamp 150 is positioned around a vehicle exhaust pipe prior to the band clamp 150 being secured to the bracket 102 by the bolt 130.

As the nut 136 is tightened on the bolt 130, the first end 152 of the band clamp 150 is pinched between the spacer 140 and the second end 134 of the bolt 130, and the second end 154 of the band clamp 150 is pinched between the spacer 140 and the domed washer 138. As a result, the band clamp 150 is tightened around an exhaust pipe (not shown).

FIG. 3 shows the first hanger rod 110 and the second hanger rod 120 attached to the bracket 102. The bracket 102, as also shown in FIG. 4, has a generally right angled portion with a flange on either end of the right angled portion.

FIG. 4 shows the bracket 102 in detail. The bracket 102 has a bottom flange 103, a base 105, a back 107, and a top flange 109. The base 105 and the back 107 are positioned generally at right angle. The base 105 has a hole 104 into which the bolt 130 is inserted. The bracket also has a first weld slot 106 and a second weld slot 108 which are generally parallel to one another and extend through the base 105 and back 107. The first weld slot 106 and second weld slot 108 provide attachment positions for the first hanger rod 110 and the second hanger rod 120, respectively. The first weld slot 106 and the second weld slot 108 are generally L-shaped slots. As such, the cylindrical rod used to form the first hanger rod 110 and the second hanger rod 120 fits partially into the first weld slot 106 and the second weld slot 108, respectively, and can be welded thereto. The first hanger rod 110 and second hanger rod 120 can be manufactured at desired lengths and with desired bends and angles to meet specifications for hanging from different vehicles. Preferably, the first hanger rod 110 and the second hanger rod 120 are welded to the bracket 102 robotically.

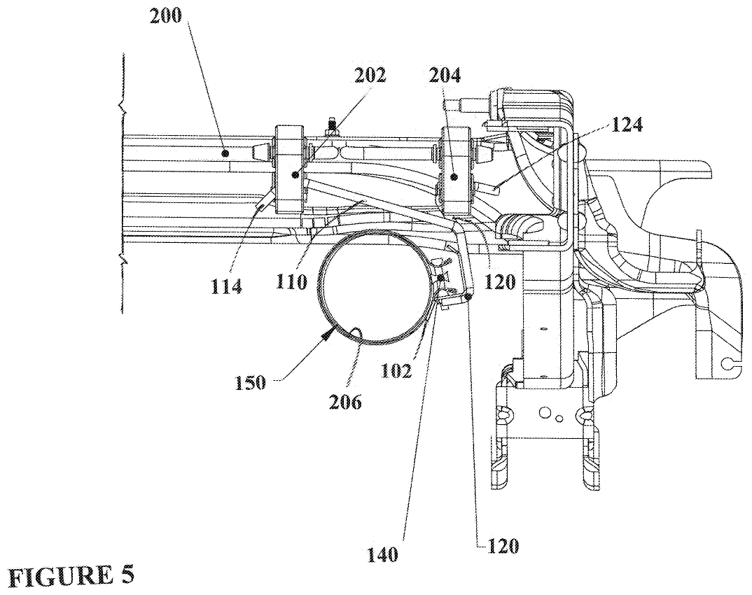

FIG. 5 shows the hanger clamp assembly 100 attached to the underside of a vehicle frame 200. As shown, the distal end 114 of the first hanger rod 110 is fitted through a first rubber insulator 202. The distal end 124 of the second hanger rod 120 is fitted through a second rubber insulator 204. As such, the hanger clamp assembly 100 is secured underneath the vehicle. An exhaust pipe 206 is secured within the band clamp 150.

In applications where the hanger clamp assembly 100 is to be fitted to a different vehicle with different configurations for the rubber insulators, the hanger rods can be made different lengths with different bends.

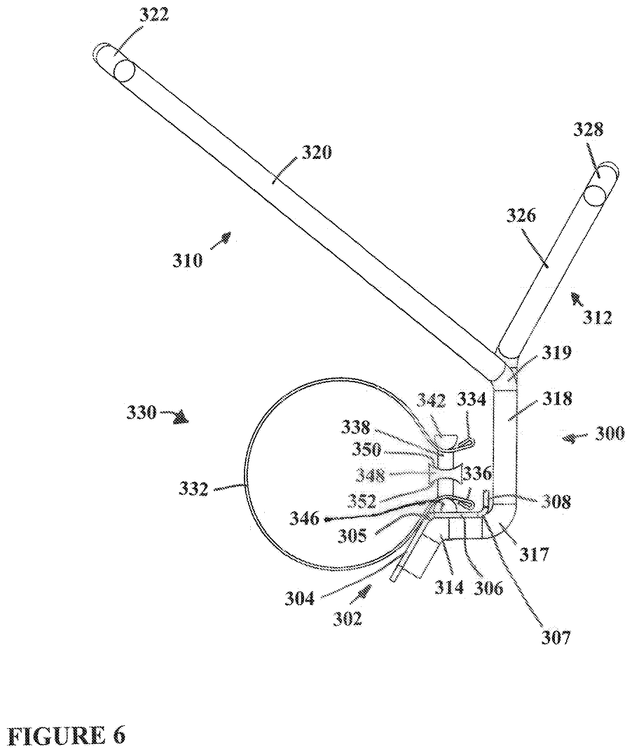

FIG. 6 shows a hanger clamp assembly 300 in accordance with another embodiment of the current invention. The hanger clamp assembly 300 has a modified S-shaped bracket 302. The bracket 302 has a first portion 304, a second portion 306, and a third portion 308. There is a first curved transition 305 between the first portion 304 and the second portion 306. There is a second curved transition 307 between the second portion 306 and the third portion 308. As shown in FIG. 6, a plane running through the first portion 304 is approximately at a 45% angle to a plane running through the second portion 306. Also, the plane running through the second portion 306 is approximately at a right angle to a plane running through the third portion 308. In this configuration, the bracket 302 has a generally modified S-shape. In a preferred embodiment, the bracket 302 has a thickness of 0.125 inches to provide adequate stiffness and durability to the bracket 302.

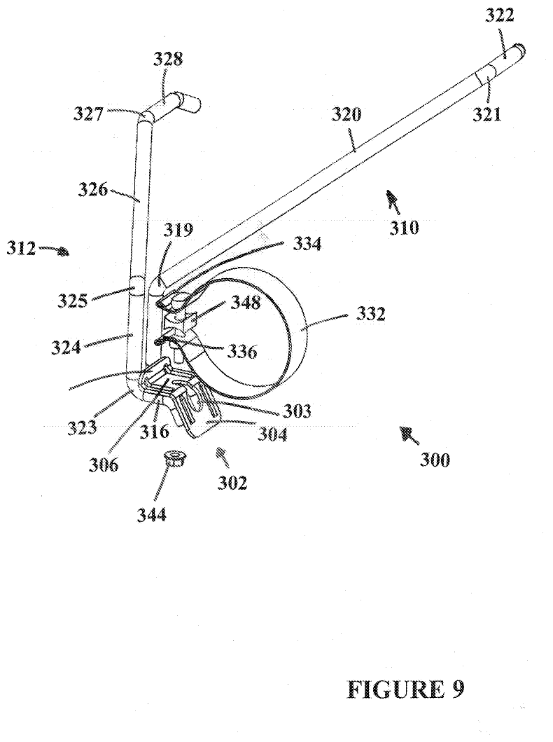

The hanger clamp assembly 300 also has a first hanger rod 310 and a second hanger rod 312, which attach the hanger clamp assembly 300 to a vehicle. The first hanger rod 310 has a curved proximal end 314 which is bent so that it substantially matches the planar generally modified S-shape of the bracket 302. The curved proximal end 312 is fixed to the bracket 302, preferably by welding. The second hanger rod 312 also has a curved proximal end 316, as shown in FIG. 9. The curved proximal end 316 is also fixed to the bracket 302, preferably by welding. The curved proximal end 316 also matches the generally modified S-shape of the bracket 302. By having the curved proximal ends 314 and 316 match the generally modified S-Shape of the bracket 302, added rigidity and strength are provided to this connection.

The first hanger rod 310 has a lower straight section 318 and an upper straight section 320 which leads to a distal end 322. The first hanger rod 310 has a first bend 317 between the proximal end 314 and the lower straight section 318, a second bend 319 between the lower straight section 318 and the upper straight section 320, and a third bend 321 between the upper straight section 320 and the distal end 322.

Similarly, the second hanger rod 312 has a lower straight section 324 and an upper straight section 326 which leads to a distal end 328. The second hanger rod 312 has a first bend 323 between the proximal end 316 and the lower straight section 324, a second bend 325 between the lower straight section 324 and the upper straight section 326, and a third bend 327 between the upper straight section 326 and the distal end 328.

The lengths of the lower straight sections 318 and 324, and the upper straight sections 320, 326 as well as the bends 317, 319, and 321, and bends 323, 325, and 327 of the first hanger rod 310 and the second hanger rod 312, respectively, are of a specified selected dimension for different vehicle applications. Thus, the hanger clamp assembly 300 can be adapted for use with different makes and models of vehicle by varying the lengths and bends of the first and second hanger rods 310, 312.

While this preferred embodiment of the hanger rod assembly 300 comprises first and second hanger rods 310, 312, it is specifically appreciated that the hanger rod assembly 300 could be constructed with only one hanger rod.

Preferably, the hanger rods 310, 312 and the bracket 302 are made of metal, namely steel. However, the hanger rods 310, 312, and/or the bracket 302 could be made from other sufficiently rigid material capable of withstanding the loads which are applied on the hanger rods 310, 312 and the bracket 302. Furthermore, while the hanger rods 310, 312 have been described as being welded to the bracket 302, it is appreciated that other methods of attachment of these components could be used including but not limited to adhesives. It is appreciated that any high volume joining process could be used to attach the components and achieve the benefits of this invention.

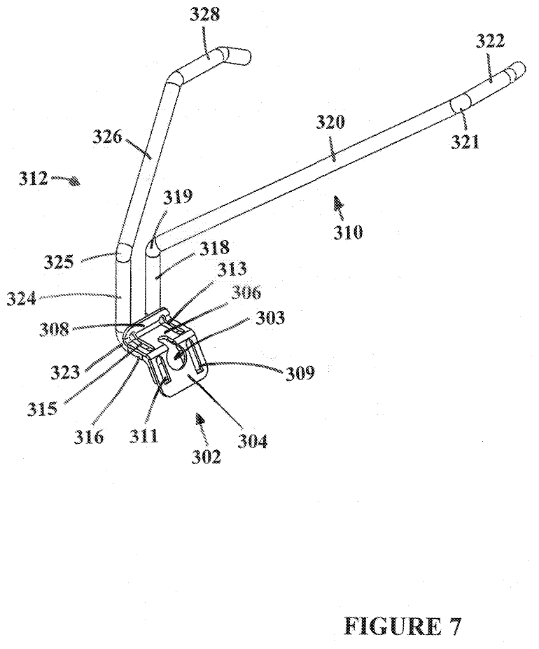

As shown in FIG. 7, the first hanger rod 310 and the second hanger rod 312 are fixed to the bracket 302. The bracket 302 has a first set of weld slots 309, 311 positioned generally parallel to one another and generally in a longitudinal orientation on the first portion 304 of the bracket 302. The bracket 302 has a second set of weld slots 313, 315 positioned generally parallel to one another and generally in a longitudinal orientation on the second portion 306 of the bracket 302. The weld slots 309 and 313 assist in accurately positioning and securing the proximal end 314 of the first hanger rod 310 on the bracket 302. The weld slots 311 and 315 assist in accurately positioning and securing the proximal end 316 of the second hanger rod 312 on the bracket 302. This better enables accuracy in welding the first and second hanger rods 310 and 312 to the bracket 302 so that the hanger rods are in a desired orientation for attachment to a particular vehicle. In a preferred embodiment, the hanger rods 310 and 312 are fixed to the bracket 302 by welding, and a width of the weld slots 309, 313 and 311, 315 is about 60% of the diameter of the respective first hanger rod 310 and the second hanger rod 312. This allows for positive location of the hanger rod 310, 312 and adequate weld bead width. Also preferably, a length of the weld slots 309, 313 and 311, 315 is 150% of the diameter of the respective first hanger rod 310 and the second hanger rod 312 to allow for adequate weld bead length.

While pairs of weld slots 309, 313 and 311, 315 have been described, it is appreciated that the weld slots 309, 313 could be one continuous slot and/or the weld slots 311, 315 could be one continuous slot. Also, in an embodiment where the hanger rods 310, 312 are attached to the bracket 302 by means other than welding, the weld slots 309, 313 and 311, 315 are beneficial in aiding in orienting the hanger rods 310, 312 in the correct alignment and provide additional surface area for attachment, such as additional surface area for attachment by adhesive.

The hanger clamp assembly 300 also has a clamp 330 attached to the bracket 302. The clamp 330 comprises a band clamp 332 having a first end 334 and a second end 336. The first end 334 and the second end 336 each have apertures (not shown) which permit a bolt 338 to pass therethrough.

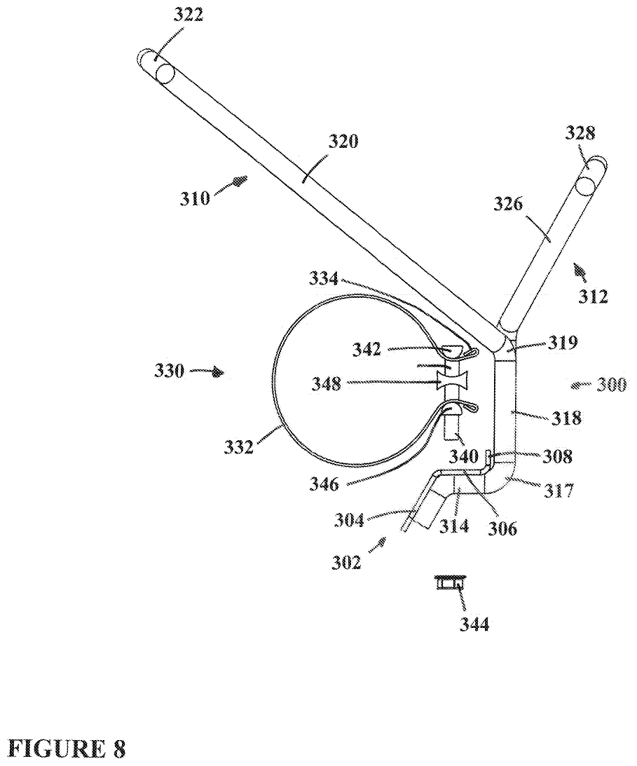

The bolt 338 has a first end 340, see FIG. 8, and a second end 342. The first end 340 is threaded and is insertable through a hole 303 in the bracket 302, as shown in FIG. 7. A nut 344 is threaded on the first end 340 to secure the bolt 338 to the bracket 302. As shown in FIG. 6, there is also a dome shaped washer 346 which is positioned on the bolt 338. A spacer 348 is also provided on the bolt. The spacer 348 has a concave profile, as shown, with an upper concave surface 350 and a lower concave surface 352. As such, when the nut 344 is tightened on the first end 340 of the bolt 338, the first end 334 of the band clamp 332 is pinched between the second end of the bolt 342 and the upper concave surface 350, and the second end 336 of the bolt 338 is pinched between the dome shaped washer 346 and the lower concave surface 352. Although a particular band clamp has been described, it is appreciated that any band clamp can be used.

In use, the band clamp 332 is positioned around a vehicle exhaust pipe prior to the band clamp 332 being secured to the bracket 302 by the bolt 338 and nut 344. As shown in FIG. 7, the hole 303 is shaped as a keyhole. This can enable the clamp 330 to be attached to the bracket 302 without requiring the use of tools. As can be visualized from FIG. 9, the nut 344 is threaded onto the first end 340 of the bolt 338, so that the nut 344 is secure but there is at least a space, which is greater than a thickness of the bracket 302, between the domed spacer 346 and the nut 344. Then the portion of the first end 340 of the bolt 338 and the nut 344 can be inserted through the larger portion of the keyhole 303, and then the bolt can be slid up into the smaller portion of the keyhole and secured therein.

Also, because the bracket 302 and first and second hanger rods 310, 312 are attachable to the clamp 330, they can be shipped unattached. This provides the advantage that the product can be more densely packed for shipping with reduced instances of bursting packaging during shipping.

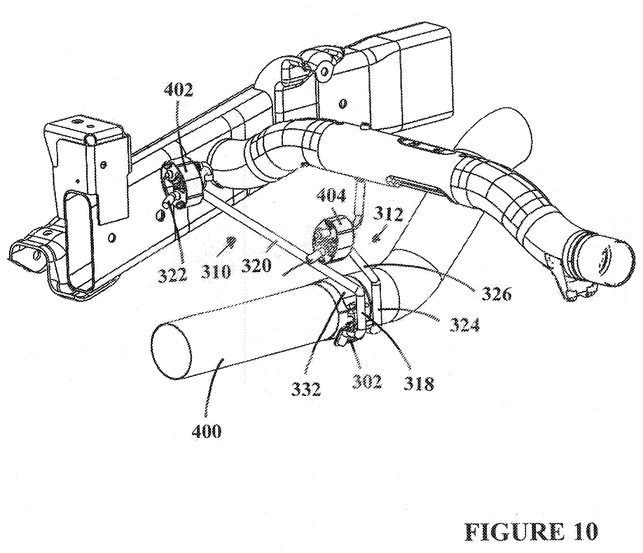

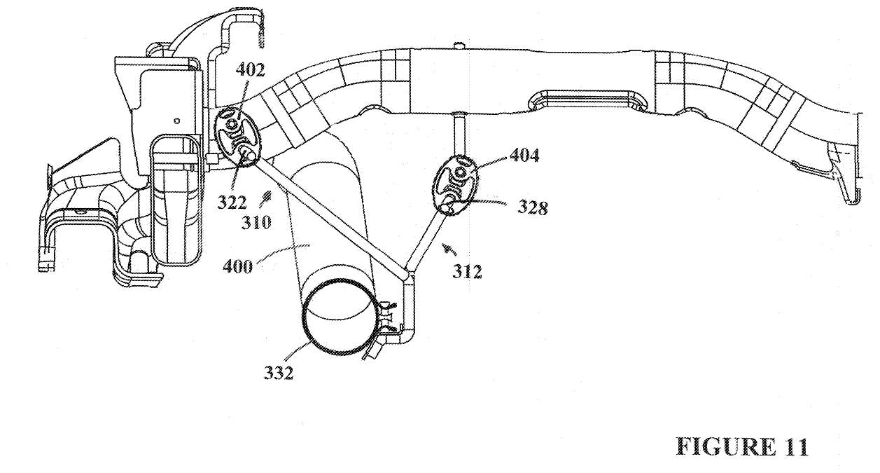

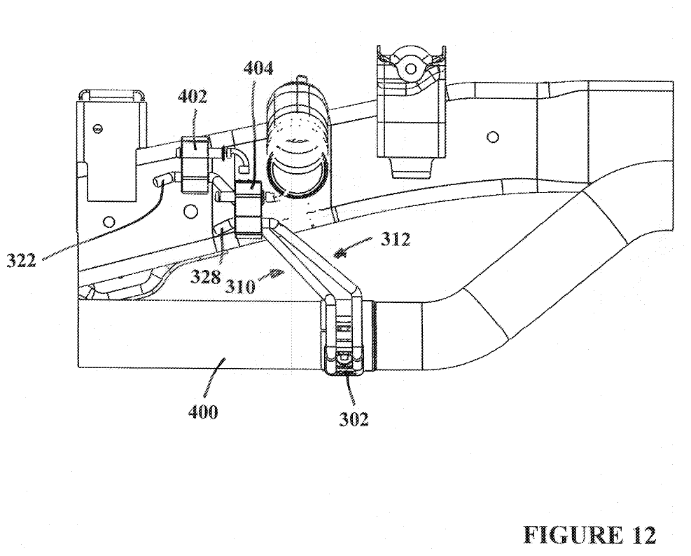

FIGS. 10 to 12 show the hanger clamp assembly 300 attached to a vehicle. As shown in FIG. 10, the band clamp 332 is positioned around an exhaust pipe 400. The band clamp 332 is attached to the bracket 302 and first and second hanger rods 310, 312. To support the hanger clamp assembly 300, the distal end 322 of the first hanger rod 310 is positioned through a hole in a first rubber insulator 402, and the distal end 328 of the second hanger rod 312 is positioned through a hole in a first rubber insulator 404.

Again, it is appreciated that the hanger clamp assembly of the current invention has been described herein has having two hanger rods, but it is contemplated that another embodiment of the current invention would comprise only one hanger rod.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

We claim:

1. A hanger clamp assembly for connecting a vehicle exhaust system to a vehicle body, comprising:
a formed bracket and one or more hanger rods being sized and bent in an orientation for a specific vehicle, each of the one or more hanger rods having a proximal end and a distal end, the proximal end of the one or more hanger rods being fixed to the formed bracket;
a clamp attached to the bracket, the clamp being sized to fit around a vehicle exhaust pipe, and
the hanger clamp assembly being connected to the vehicle by attaching the distal end of the one or more hanger rods to a mount one or more mounts on the underside of the vehicle and a vehicle exhaust pipe being secured within the clamp.

2. The hanger clamp assembly of claim 1, wherein the bracket further has at least one first weld slot, and the proximal end of the at least one hanger rod is fixed to the at least one first weld slot.

3. The hanger clamp assembly of claim 2, wherein the at least one weld slot has a width that is approximately 60% of a diameter of the at least one hanger rod.

4. The hanger clamp assembly of claim 3, wherein the at least one weld slot has a length that is approximately 150% of the diameter of the at least one hanger rod.

5. The hanger clamp assembly of claim 1, wherein there are two hanger rods, namely a first hanger rod and a second hanger rod, and each of the first and second hanger rods are fixed to the formed bracket.

6. The hanger clamp assembly of claim 5, wherein the bracket further has at least one first weld slot and at least one second weld slot, and the proximal end of the first hanger rod is welded to the at least one first weld slot, and the proximal end of the second hanger rod is welded to the at least one second weld slot.

7. The hanger clamp assembly of claim 6, wherein the at least one first and the at least one second weld slots have a width that is approximately 60% of a diameter of the respective first and second hanger rods.

8. The hanger clamp assembly of claim 7, wherein the at least one first weld slot and the at least one second weld slot have a length that is approximately 150% of the diameter of the respective first and second hanger rods.

9. The hanger clamp assembly of claim 8, wherein the formed bracket is generally a modified S-shape.

10. The hanger clamp assembly of claim 5, wherein the formed bracket is generally a modified S-shape.

11. The hanger clamp assembly of claim 10, wherein the proximal end of the at least one hanger rod is cylindrical and is bent in substantially a same shape as a contour of the modified S-shape of the bracket.

12. The hanger clamp assembly of claim 1, wherein the formed bracket is generally a modified S-shape.

13. The hanger clamp assembly of claim 12, wherein the proximal end of the at least one hanger rod is cylindrical and is bent in substantially a same shape as a contour of the modified S-shape of the bracket.

14. The hanger clamp assembly of claim 13, wherein there are two hanger rods, namely a first hanger rod and a second hanger rod, and each of the first and second hanger rods are fixed to the formed bracket.

15. The hanger clamp assembly of claim 13, wherein the hole has a keyhole shape.

16. The hanger clamp assembly of claim 1, wherein the clamp is a standard commercially available band clamp.

17. The hanger clamp assembly of claim 1, wherein the bracket has a hole therethrough, and the band clamp has a bolt for tightening the band around an exhaust pipe, the hole in the bracket being sized such that the bolt is insertable therethrough and a nut is threadable onto the end of the bolt to secure the bracket to the band clamp.
